(19) United States
(12) Patent Application Publication
(10) Pub. No.: US 2016/0303965 A1
(43) Pub. Date: Oct. 20, 2016

(54) FUEL SYSTEM ASSEMBLIES

(71) Applicant: AGILITY FUEL SYSTEMS, INC., Santa Ana, CA (US)

(72) Inventors: Todd F. Sloan, Kelowna (CA); Chris Forsberg, Kelowna (CA); Andrew Taylor Gordon, Kelowna (CA)

(21) Appl. No.: 15/097,804

(22) Filed: Apr. 13, 2016

Related U.S. Application Data
(60) Provisional application No. 62/147,513, filed on Apr. 14, 2015.
(60) Provisional application No. 62/147,526, filed on Apr. 14, 2015.

(51) Int. Cl. B60K 15/063; B60K 15/073

(52) U.S. Cl. CPC B60K 15/063; B60K 15/073; B60K 2015/0639; B60K 2015/03309

(57) ABSTRACT

An elongate structural member is provided that can be integrated into a fuel system support assembly. The elongate structural member can be a multifunctional member, for example including a support portion for supporting a catwalk or segment of a fuel line and an auxiliary anchor feature that comprises a channel extending the length thereof. The elongate structural member can be an extrusion with the support portion and the anchor feature extending the entire length thereof.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. §1.57.

### BACKGROUND OF THE INVENTION

1. Field of the Invention

This application is directed to a support system for a vehicle fuel system, for example for a compressed gas fuel system for transit vehicles such as large buses, for trucks of various types, or other vehicles.

2. Description of the Related Art

Large buses are a type of transit vehicle that are widely used for mass transit. While in the past such vehicles have been powered by gasoline or diesel burning engines, a growing trend toward alternative fuel sources has emerged. An example of such fuel sources is compressed natural gas.

It is known to mount compressed natural gas fuel systems on the roof of a bus. While this location has some advantages, there are significant challenges in integrating the roof mounted system with the vehicle. For example, the fuel system has to be secure. Conventional techniques for securing a fuel system to a roof of a bus rely on sourcing a large number of components from different suppliers. This sourcing approach is not cost efficient. Also, prior roof mount support structures are configured for mounting only specific components at specific locations, for example by having arrays of bolt holes or other fixed location fasteners not permitting modification of mounting location of or the addition of components.

For the forgoing reasons there is a need for improved systems for integrating a fuel system into a variety of vehicles including transit vehicles, in a variety of mounting locations including roof mounts.

### SUMMARY OF THE INVENTION

In some embodiments, improved frame assemblies and members are provided that improve the integration of a fuel system with a vehicle, such as a bus or other transit vehicle. The frame or support members can include, perform or provide multiple functions, e.g., supporting multiple components from novel anchor features, providing part of a fluid passage of a portion of a fuel system, and other functions and thus are sometimes referred to herein as multifunctional members. These multifunctional support members can be included in innovative fuel system assemblies as described and claimed herein.

In one embodiment, a fuel system support assembly is provided. The support assembly includes an elongate structural member, a utility access platform, and an auxiliary component. The elongate structural member has a first end, a second end, a first surface configured to be horizontally oriented and a second surface configured to be vertically oriented when the elongate structural member is mounted to a roof of a transit vehicle. The second surface has an anchor feature formed or disposed therein and disposed along the length of the elongate structural member. The anchor feature extends from at least one of the first and second ends toward the other of the first and second ends. The utility access platform is disposed above and supported by the first surface of the elongate structural member. The auxiliary component is coupled with the anchor feature.

In some embodiments, an elongate structural member is configured as a multifunctional member. The elongate structural member can comprise an anchor feature disposed on an inboard or outboard side of the structural member. In one example, the multifunctional member includes a support portion and an anchor feature that comprises a channel extending the length thereof.

The elongate structural members can include a retention feature for attaching other fuel system components, such as tube clamps for securing fluid conduits of the system. In certain embodiments, the elongate structural members can be configured for routing of wire harnesses. The elongate structural members can be arranged for attachment of lifeline safety anchors. In some cases, the elongate structural members can act as gas-carrying members. The elongate structural member can be configured with internal cavities to hold or to convey pressurized fuel. In some embodiments, the elongate structural members can support a pressure relief device, for example a device activated by heat or a manually activated device.

In some embodiments, an auxiliary component that can be supported by an elongate structural member comprises a lifeline anchor connection.

In another embodiment, a roof mounted fuel system safety assembly is provided. The safety assembly includes an elongate structural member and a lifeline anchor. The elongate structural member has a first end and a second end. The elongate structural member is configured to be disposed along the roof of a transit vehicle or another type of vehicle. The elongate structural member has a plurality of channels extending from at least one of the first and second ends toward the other of the first and second ends. The lifeline anchor connection comprises a first protrusion slideably received in one of the channels and a fastening device slideably received in another one of the channels.

In another embodiment, a fuel system support assembly is provided that includes a fuel pressure vessel, a fuel passage, and an elongate structural member. The fuel passage is coupled with the fuel pressure vessel for conveying fluid into or out of the fuel pressure vessel. The elongate structural member has a first end, a second end, a first surface extending between the first and second ends, and a second surface extending between the first and second ends. The first surface can be configured to be horizontally oriented when the elongate structural member is mounted to a roof of a vehicle. The second surface can be configured to be vertically oriented when the elongate structural member is mounted to a roof of a vehicle. The first surface has formed therein an anchor feature disposed along the length of the elongate structural member. The anchor feature extends from at least one of the first and second ends toward the other of the first and second ends. A pressure manifold supported from the anchor feature is in fluid communication with the fuel pressure vessel. In some embodiments, the pressure manifold can be disposed at an elevation below the pressure vessel when supported by the anchor feature.

In another embodiment, a fuel system cover assembly is provided that includes a structural member, a hinge, and a fuel pressure vessel cover. The structural member has an outboard side, an inboard side, a first end configured to couple with a vehicle at a first location, a second end configured to couple with the vehicle at a second location. The structural member includes an elongate body disposed between the first and second ends. The elongate body has an arcuate channel disposed therein. The arcuate channel is open along one side thereof. The hinge has a cylindrical portion disposed in the arcuate channel and a coupler disposed away from the cylindrical portion. The fuel pressure vessel cover is secured to the coupler of the hinge.

In a first application, the arcuate channel can be disposed along the outboard side of the vehicle when the fuel system is coupled with a roof of the vehicle. The arcuate channel can be open to the outboard side.

In various embodiments, the elongate body can also have an auxiliary anchor feature. The auxiliary anchor feature can be disposed on a side of the structural member opposite the arcuate channel. For example, if the arcuate channel is on the outboard side of the structural member, the auxiliary channel can be disposed on an inboard side thereof. If the arcuate channel is on the inboard side of the structural member, the auxiliary channel can be disposed on an outboard side of the thereof. The auxiliary anchor feature configured to couple with an auxiliary component.

In various embodiments, the structural members comprise extrusions that have a plurality of independent channels extending the length thereof to anchor separate fuel system components. In various embodiments, the structural members comprise multifunctional extrusions.

In another embodiment, a structural member for securing components of a fuel system to a vehicle frame is provided. The structural member includes a first end, a second end, and an elongate body extending therebetween. The elongate body has a first surface that has a first anchor feature formed therein. The first anchor feature extends from at least one of the first and second ends toward the other of the first and second ends. The first anchor feature has having sufficient length to permit a component to be mounted thereto at a range of positions. The elongate body has a second surface that has a second anchor feature formed therein. The second anchor feature extends from at least one of the first and second ends toward the other of the first and second ends. The second anchor feature has sufficient length to permit a component to be mounted thereto at a range of positions.

In some embodiments, an improved fuel system cover hinge is provided that allows the cover to be adjusted by small amounts to improve the fit of the cover over the fuel pressure vessels. This improved fit enhances protection of the fuel system from the elements, as well as the appearance of the vehicle. Improved fit can have some aerodynamic advantages as well, which contributes to the fuel efficiency of the vehicle overall.

In one embodiment, a fuel system cover assembly is provided that includes a support member, a hinge and a cover. The support member has a hinge portion disposed on an outboard side thereof. The support member has a lower portion that is configured to couple with a roof of a vehicle, e.g., a bus or other transit vehicle. The hinge has a pivotable portion, which can be a cylindrical member, pivotably coupled with the hinge portion of the support member. The hinge has a free end disposed away from the pivotable portion, e.g., cylindrical member. The free end has a follower surface disposed thereon. The cover has a lower portion that has an inside surface coupled with the free end of the hinge such that the pivoting of the hinge also pivots the cover. The cover can thus be moved from a covering position in which a fuel pressure vessel is covered to an exposed position in which the fuel pressure vessel is exposed. The cover assembly also has a cam rotatably mounted on the cover. The cam has a cam surface engaged with the follower surface. Rotation of the cam causes the cam surface to act on the follower surface. As the cam surface acts on the follower surface, an adjustment is made in a gap between a lower edge of the lower portion of the cover and an adjacent portion of a vehicle with which the fuel system cover assembly is coupled.

In some embodiments, the support member of the fuel system cover assembly comprises an anchor feature disposed on an inboard side of the support member. The support member can be a multi-functional member, for example, a hinge portion that comprises a channel and an anchor feature comprising a channel extending the length thereof.

In another embodiment, a fuel system cover assembly is provided that includes a support member, a hinge, a cover, and an adjustment device. The support member has a lower section configured to couple with a roof of a vehicle. The hinge has a first portion coupled with the support member and a second portion disposed away from the first portion. The hinge enables the second portion to pivot relative to the support member. The cover has a lower portion coupled with the second portion of the hinge such that pivoting of the hinge moves the cover from a first position covering a fuel pressure vessel to a second position exposing the fuel pressure vessel. The adjustment device is disposed between the second portion of the hinge and the cover. The adjustment device enables movement of the cover relative to the hinge to improve fit of the cover disposed over the fuel pressure vessel.

A variety of adjustment devices are possible. Various forms that can be used provide for small changes or fine adjustments in a gap formed at a seam between the cover and the roof of the vehicle or another structure therebetween. One such fine adjustment device comprises a cam interface disposed between the cover and the hinge or between the hinge and the vehicle roof. Other forms of adjustment device can include a pin in a track, a gear device, and/or a device for translating rotational motion into linear motions. A lever could be provided that activates a cam or gear or even a linkage in some variations.

In another embodiment, a fuel system cover assembly is provided that includes a moveable coupler, e.g., a hinge configured to be anchored and moveable, e.g., pivotable, relative to a surface of a transit vehicle. The coupler, e.g., hinge, preferably has a follower surface disposed thereon. The cover is coupled with the coupler, e.g., hinge such that the cover can be opened and closed. The fuel system cover assembly also includes an adjustment device coupled with the cover and with the hinge. The adjustment device is configured to adjust the closed position of the cover relative to the surface of the transit vehicle.

In some embodiments, the adjustment device includes a cam pivotably coupled with the cover. The cam has a cam surface engaged with the follower surface such that rotation of the cam causes the cam surface to act on the follower surface to adjust the closed position of the cover relative to the surface of the transit vehicle.

A fuel system cover assembly is provided that includes a hinge configured to be anchored and pivotable relative to a surface of a vehicle, such as a bus or other transit vehicle. The hinge preferably has a follower surface disposed thereon. The cover is coupled with the hinge such that the cover can be opened and closed. The fuel system cover assembly also includes an adjustment device, such as a cam pivotably coupled with the cover. The cam has a cam surface engaged with the follower surface such that rotation of the cam causes the cam surface to act on the follower surface to adjust the closed position of the cover relative to the surface of the vehicle.

### BRIEF DESCRIPTION OF THE DRAWINGS

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

FIG. 1 is a perspective view of a transit vehicle having a fuel system mounted on a roof thereof;

FIG. 2 is a top view of the transit vehicle of FIG. 1 showing a utility access platform and a plurality of fuel system covers;

FIGS. 3-4 are perspective detailed views of the utility access platform and covers, the covers shown in closed and open positions respectively;

FIG. 4A shows a fuel system support assembly according to one embodiment;

FIG. 5 shows a fuel system roof mount system including one embodiment of a multifunctional support member;

FIG. 6 is a perspective view of the multifunctional support member of FIG. 5;

FIG. 7A is an end view of the multifunctional support member of FIG. 5;

FIG. 7B is a plan view of a portion of an inboard side of the multifunctional support member of FIG. 5;

FIG. 7C is a plan view of a portion of an outboard side of the multifunctional support member of FIG. 5;

FIG. 8 is a perspective view of an embodiment of a roof mounted fuel system safety assembly;

FIG. 9 is a bottom view of the fuel system roof mount system, showing another embodiment of a multifunctional support member;

FIG. 10 is a perspective view of the multifunctional support member of FIG. 9;

FIG. 11A is an end view of the multifunctional support member of FIG. 9;

FIG. 11B is a plan view of a portion of a bottom side of the multifunctional support member of FIG. 9;

FIG. 11C is a plan view of a portion of a side portion, which can be a front or rear-facing side, of the multifunctional support member of FIG. 9;

FIG. 12 is a perspective and partial side view of an embodiment of a fuel system cover assembly, showing another embodiment of a multifunctional support member;

FIG. 12A is a bottom perspective view of the assembly in FIG. 12;

FIG. 13 is a top perspective view of the multifunctional support member of FIG. 12;

FIG. 14A is an end view of the multifunctional support member of FIG. 12;

FIG. 14B is a plan view of a portion of an inboard side of the multifunctional support member of FIG. 9;

FIG. 14C is a plan view of a portion of an outboard side of the multifunctional support member of FIG. 9;

FIGS. 15-16 illustrate features of a cover adjustment device that can be integrated into embodiments of the roof mount systems disclosed herein.

FIG. 17 is a perspective view of a portion of a fuel system showing a conventional vent passage configuration;

FIG. 18 is a perspective view of a novel fuel system including a vent passage portion of a multifunctional support member into which the vent passage is integrated;

FIG. 19 further illustrates a multifunctional support member with an integrated fluid passage, such as an integrated vent passage;

FIG. 20 is another embodiment of a multifunctional support member with an integrated fluid passage;

FIG. 21 is another embodiment of a multifunctional support member with an integrated fluid passage;

FIG. 22 is an end view of another embodiment of a multifunctional support member with a plurality of integrated fluid passages; and

FIG. 23 is a perspective view of the support member of FIG. 22.

### DETAILED DESCRIPTION OF THE PREFERRED EMBODIMENT

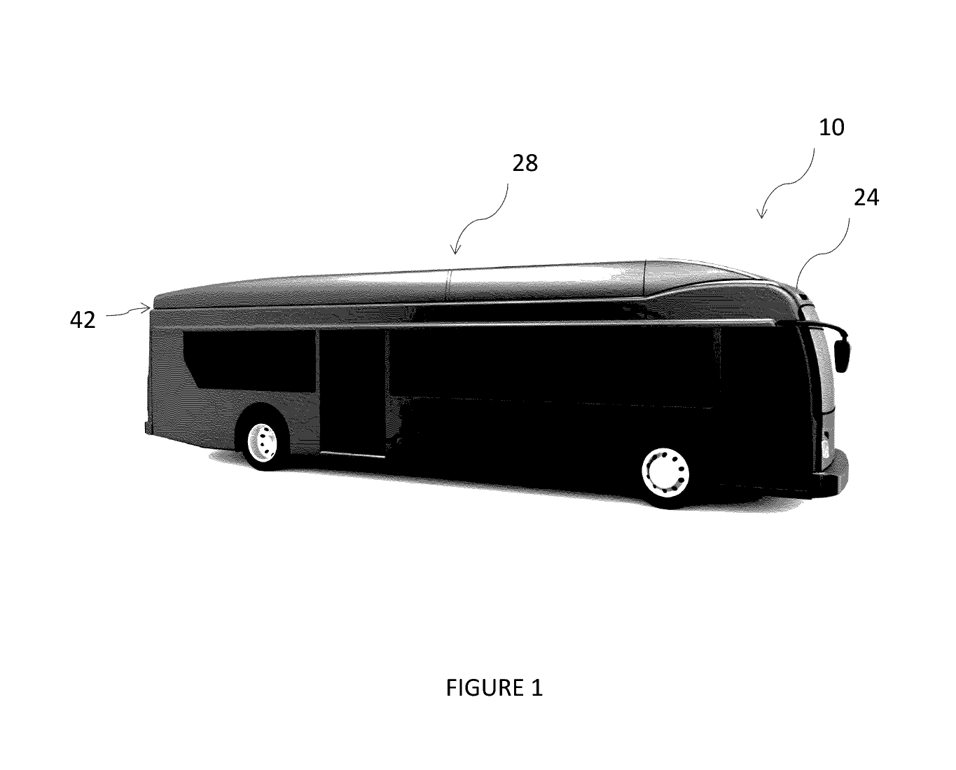

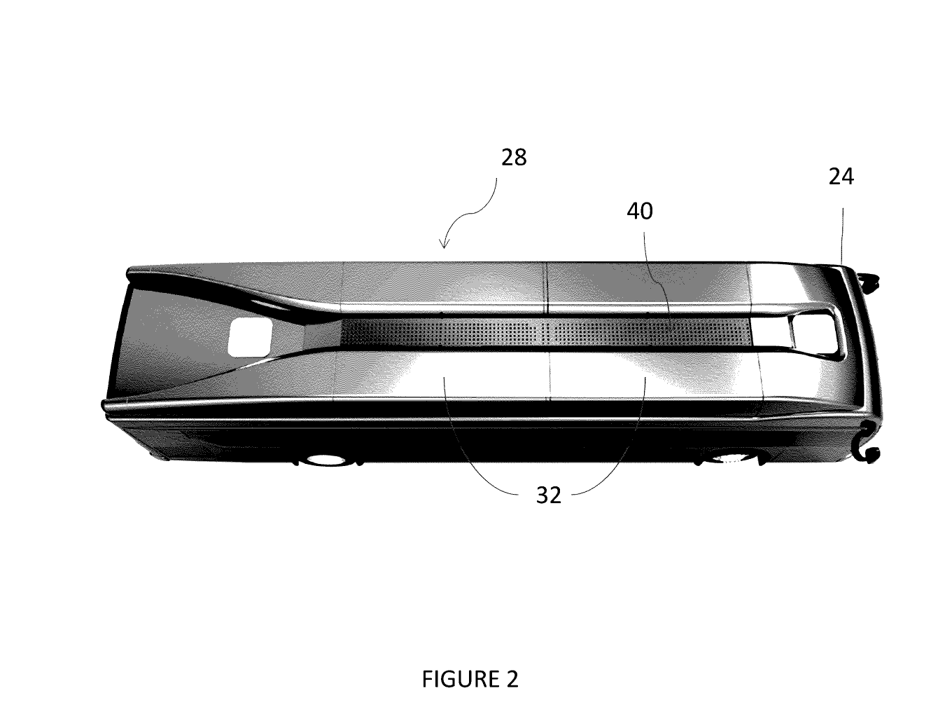

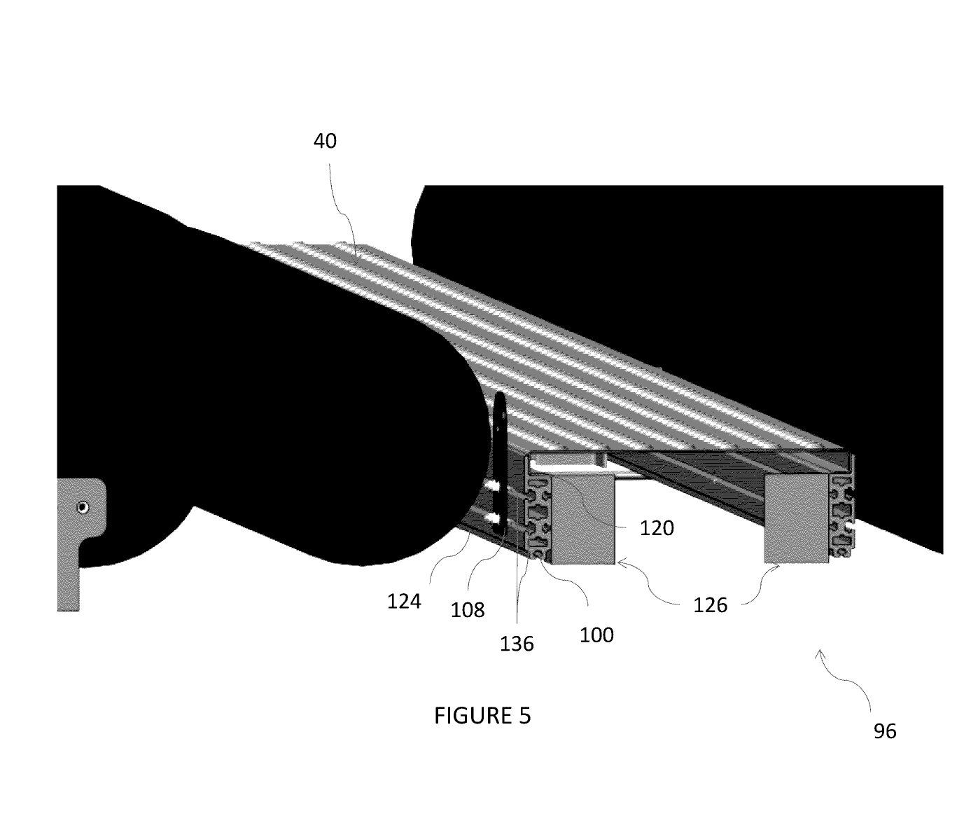

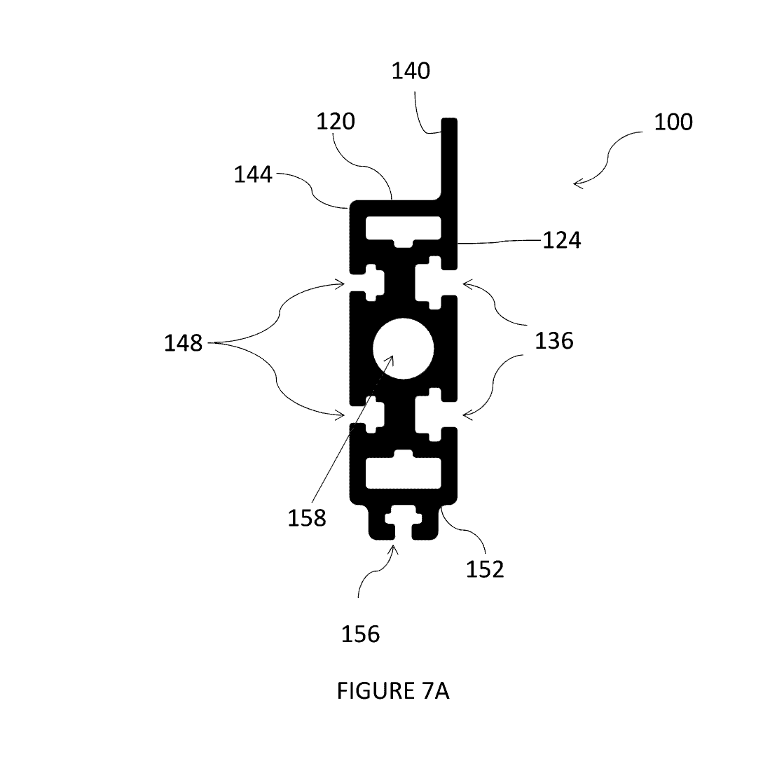

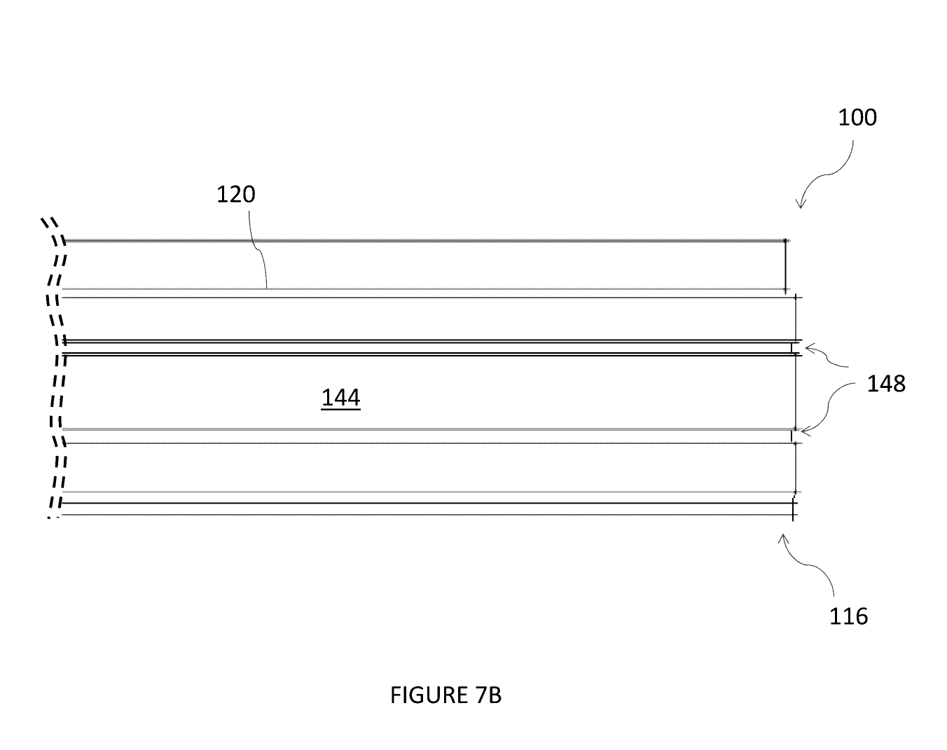

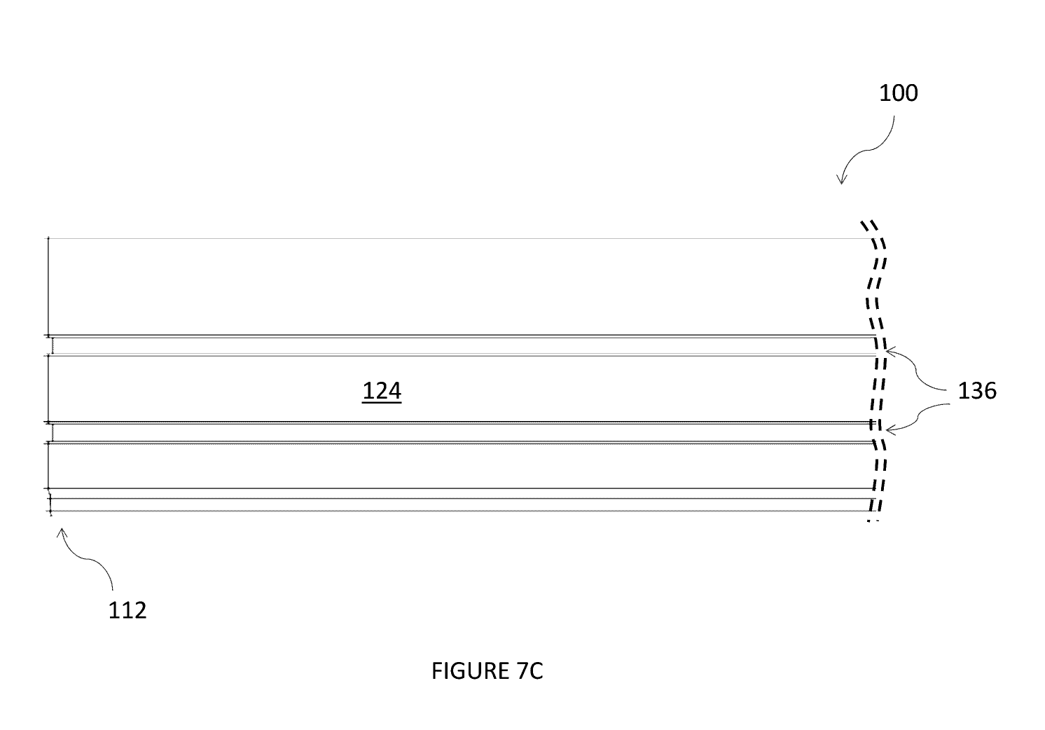

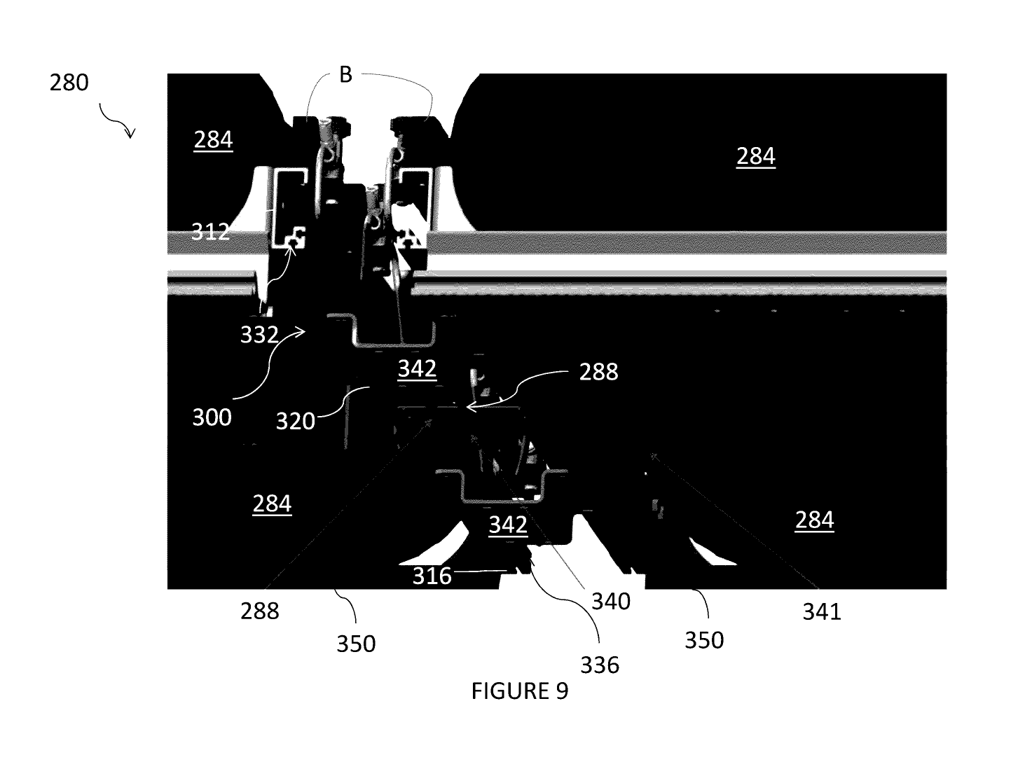

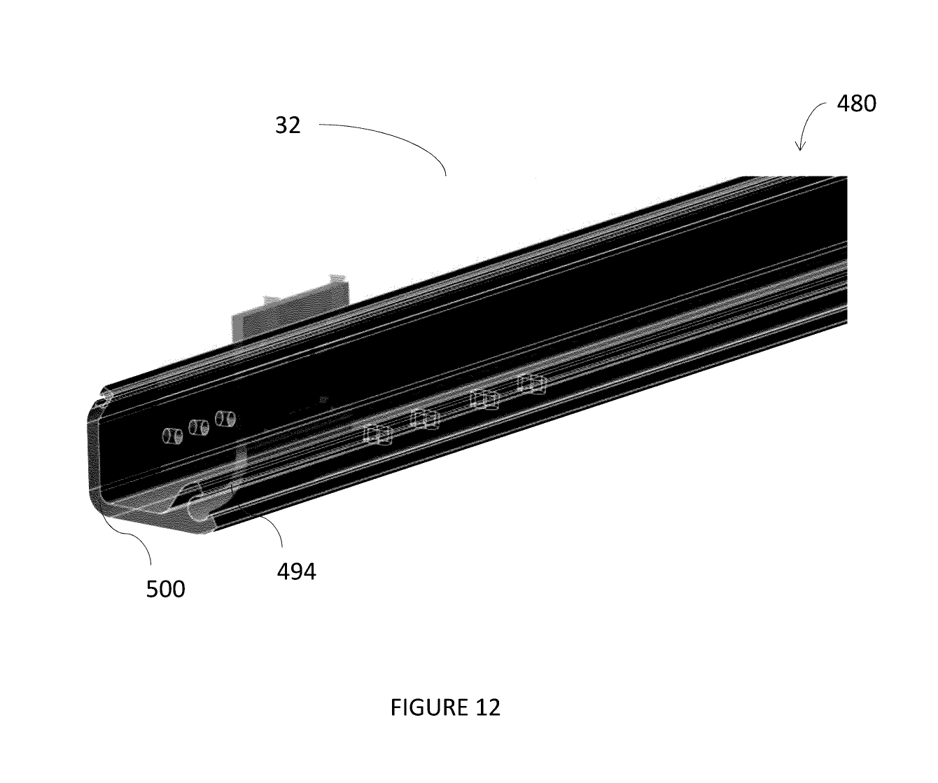

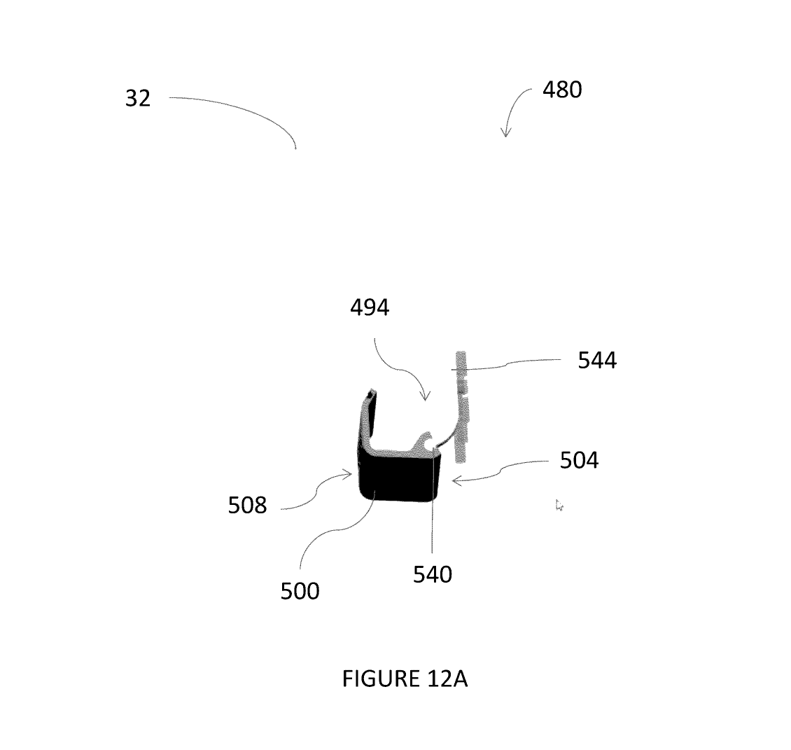

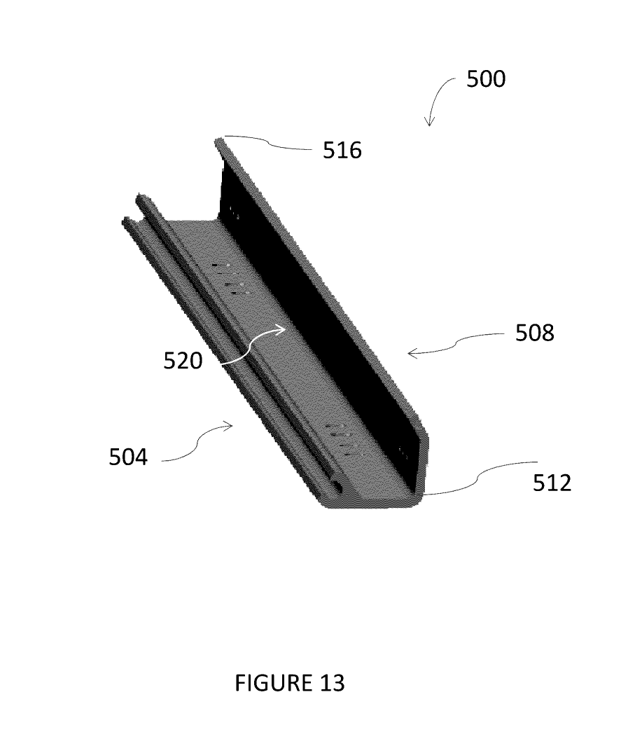

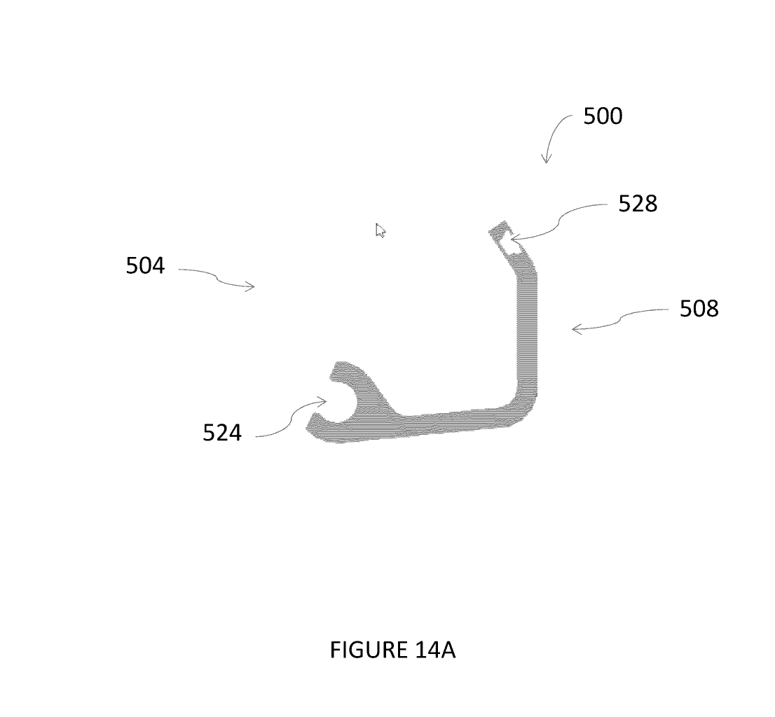

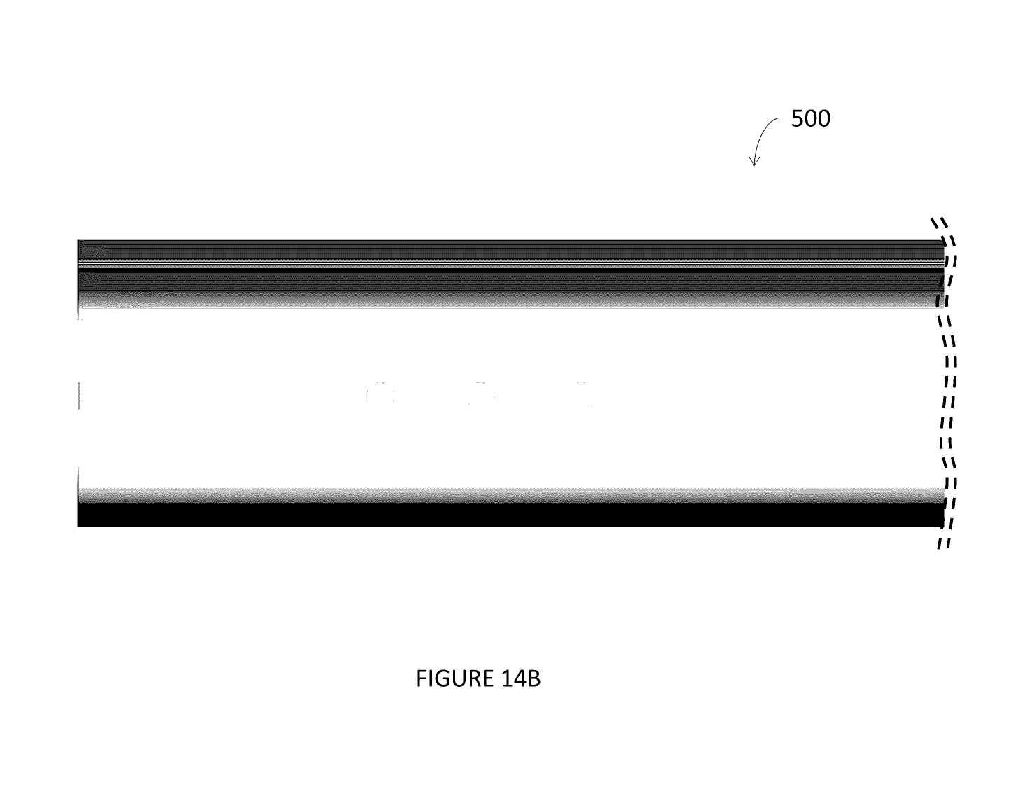

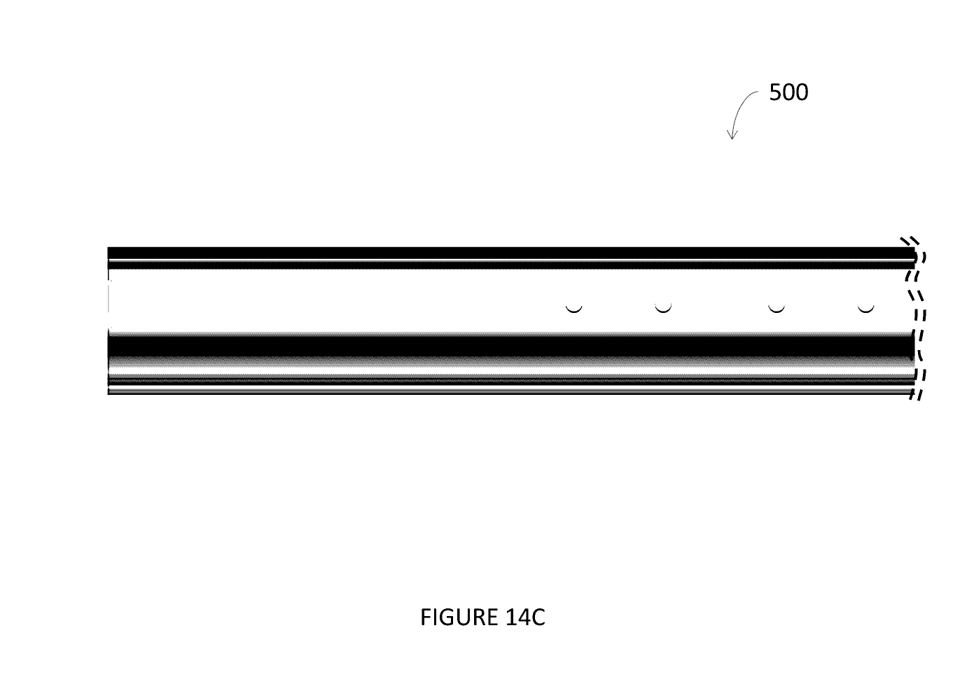

This application is directed to novel approaches for integrating a fuel system into a vehicle, particularly into transit vehicles, such as illustrated by FIGS. 1-4. FIGS. 5-14C illustrate support members that provide multiple functions. For example, a support member 100 illustrated in FIG. 5 supports a utility access platform and provides anchor features for securing other components. FIG. 9 illustrates a support member 300 that provides an anchor feature on one portion and a pressure manifold support on another portion and located in a manner simplifying routing and connecting of the fuel manifold. FIG. 12 illustrates a support member 500 that supports a hinge on an outboard side and an anchor feature disposed on an inboard side for supporting other components. FIGS. 12, 12A and 15-16 illustrate an adjustable hinge that improves the fit of a cover disposed over the fuel system. FIGS. 7A and 19-21 illustrates support members that have integrated fluid passages. These innovations are discussed in greater detail below significantly advance the state of the art of fuel system integration.

### I. Transit Vehicle with Roof Mount Fuel System

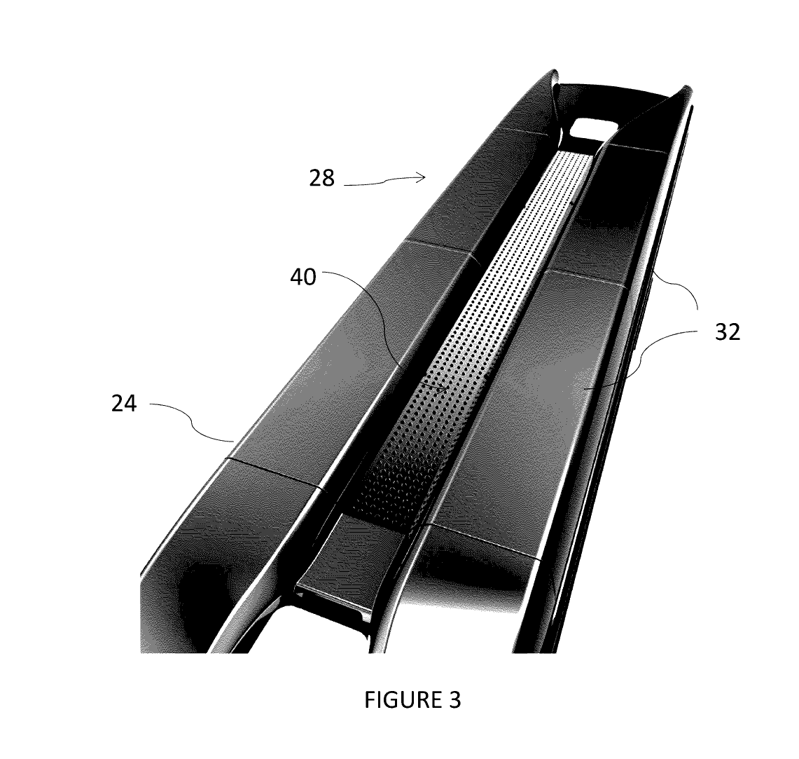

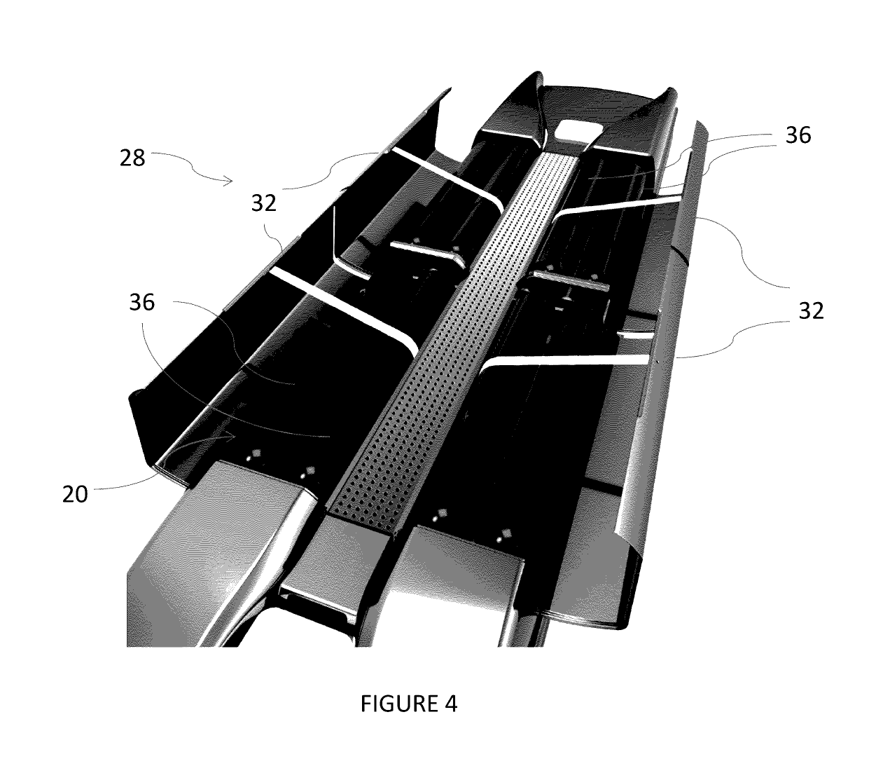

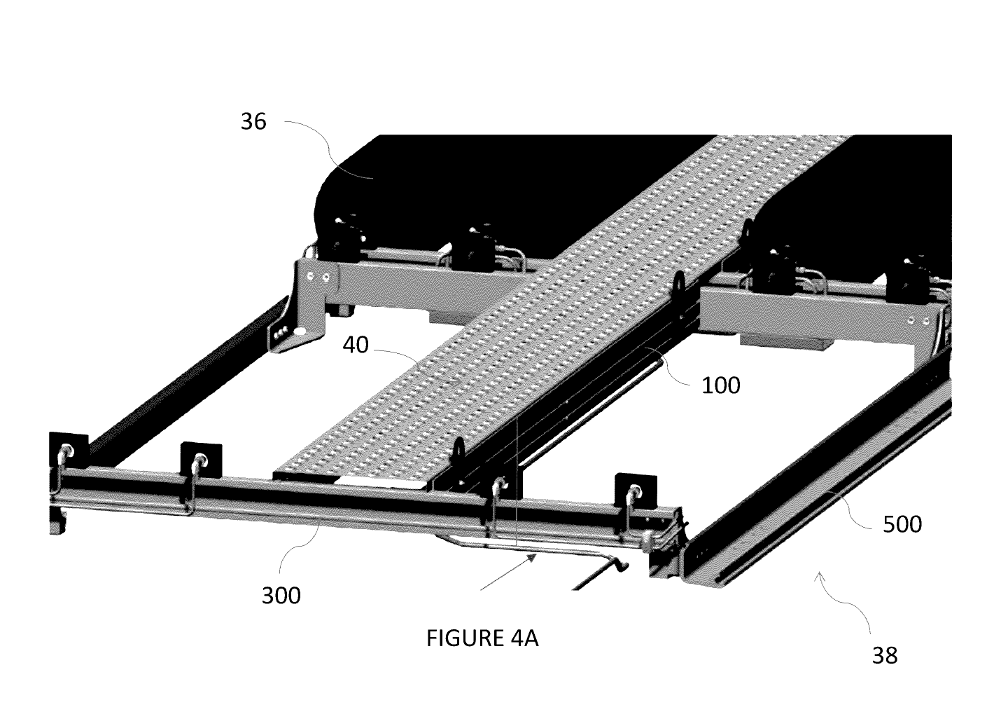

FIGS. 1-4 show a bus 10 which is a common type of transit vehicle with which embodiments of this application can be used. The vehicle has room for many passengers and can be powered by an efficient alternative fuel, such as compressed natural gas, or any other fuel. The bus 10 has a fuel system 20 mounted on a roof 24 thereof. The fuel 20 is enclosed with a housing 28 that includes one or more covers 32. In the illustrated embodiment, the housing 28 includes four covers 32 that can be closed and opened as shown in FIGS. 3 and 4.

The housing 28 provides access to one or more fuel pressure vessels or pressure vessels 36 when open and provide protection for the fuel system 20 when closed. The pressure vessels 36 can store any suitable fuel, for example compressed natural gas. In the illustrated embodiment, there are eight fuel pressure vessels 36. FIG. 4A shows that the support members 100, 300, 500 can be combined into a fuel system frame assembly 38 that can support the pressure vessels 36 and other components of the fuel system. Each cover 32 encloses two fuel pressure vessels 36 when closed. Other numbers of pressure vessels and arrangements on the vehicle are possible. The number and layout are just for illustration. A utility access platform 40, which is sometimes referred to herein as a catwalk, is disposed on the roof 24 of the bus 10. As discussed further below, embodiments of a fuel system support system disclosed herein also support the platform 40. In some embodiments, the fuel system support system also provide anchor features for safety components related to the use of the utility access platform 40.

FIG. 1 illustrates an integration challenge with roof mount fuel systems. The covers 32 meet the roof 24 at a seam 42. The seam 42 should be small and uniform along the length of the lower surface of the cover to maintain good protection against the harsh elements that transit vehicles must endure.

### II. Multifunctional Support Assemblies for Fuel Systems

In various embodiments, structural members are configured to support a plurality of components along various portions of a fuel system support system.

### A. Multifunctional Support Elements Including Catwalk Support

In one embodiment, a fuel system support assembly 96 is provided. The support assembly 96 includes an elongate structural support member 100, the utility access platform 40, and an auxiliary component 108. The elongate structural member 100 has a first end 112, a second end 116, a first surface 120 and a second surface 124. The first surface 120 can be used in an assembly to support another component of a fuel system, such as the access platform 40. The first surface 120 can be disposed beneath the access platform 40. The first surface 120 can be horizontally oriented to provide this support function, but can have other orientations while supporting the access platform 40. A support portion 121 can comprise a portion of the first surface 120 that directly or indirectly supports the platform 40. The second surface 124 can be disposed transverse relative to the first surface 120. The second surface 124 can be configured to be vertically oriented when the elongate structural member 100 is mounted to a roof of a transit vehicle. The elongate structural member 100 can be coupled with the roof in any suitable way, such as with one or more brackets 126.

The second surface 120 has an anchor feature 136 formed therein and disposed along the length of the elongate structural member 100. The anchor feature 136 extends from at least one of the first end 112 and second end 116 toward the other of the first end 112 and the second end 116. The anchor features 136 can be shaped to receive a protrusion of a component or a custom or standard fastener. For example, the anchor features 136 can include a slot having a narrow slot opening at the surface 120 and a wider space behind the opening. This allows fasteners and connectors to slide into the anchor features 136 at the ends thereof and along the length of the anchor features 136 but not pull out of the anchor features 136 in a direction perpendicular to the longitudinal direction of the anchor features 136. In one embodiment, the profile of the anchor features 136 from the end view or at a transverse cross-section includes a perimeter that can receive the head of a bolt or another component having a wider profile near one end and a slender neck extending away from the wider profile and through the opening of the anchor feature 136.

The utility access platform 40 is disposed above and supported by the first surface 120 of the elongate structural member 100. FIGS. 5 and 7A show that the first surface 120 can be disposed adjacent to a lateral support 140 configured to provide some lateral support to the utility platform 40. The lateral support 140 can limit or prevent motion of the platform along the surface 120.

The auxiliary component 108 is coupled with the anchor feature 136. FIG. 5 shows that the auxiliary component 108 can include a lifeline anchor that can include a flat member that protrudes above the platform 40. The flat member has a large hole in it to attach to a hook or other securement device.

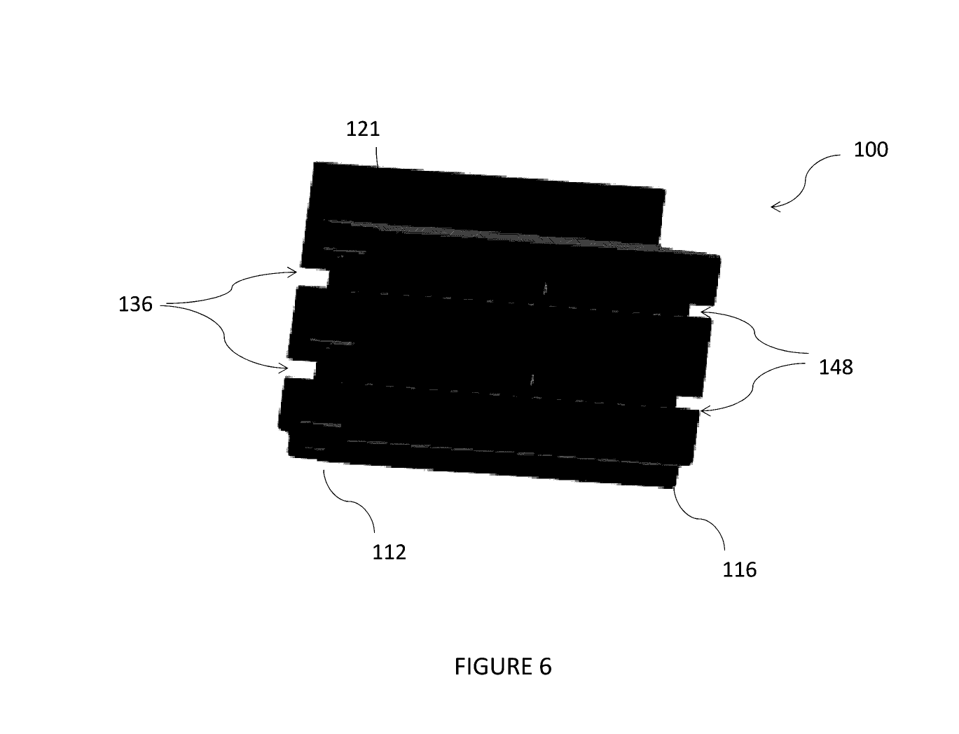

FIGS. 6 and 7A show that in some embodiments, the elongate structural member 100 a third surface or side 144 having at least one anchor feature 148 disposed therein. The anchor feature 148 comprises two channels. The third side 144 can be one that is parallel to the surface 124, e.g., one that is vertically oriented when the elongate structural member 10 is mounted to a roof of a transit vehicle. In some assemblies the first side 124 is an outboard side of the member 100, e.g., a side that is the surface is facing away from a central, vertical longitudinal plane of the vehicle. In some assemblies the third side 144 is an inboard side of the member 100, e.g., a side that faces toward the central, vertical longitudinal plane of the vehicle. In other embodiments, the third side can be along a bottom edge of the member 100, e.g., an edge or surface that faces toward the bottom of the vehicle.

In some embodiments, the elongate structural member 100 comprises a fourth surface or side 152 that has an anchor feature 156 disposed therein. The fourth side 152 is configured to be horizontally oriented when the elongate structural member 100 is mounted to a roof top of a transit vehicle. FIGS. 5 and 7A shows the orientation of the elongate structural member 100 in certain embodiments, in which the surface 120 is at the top, the surface 124 is on an outboard side, and the third side 144 is on an inboard side.

The elongate structural member 100 is a multifunctional member in the illustrated embodiment, in that the member provides a function of supporting the utility access platform 40 and of securing the auxiliary component 108, which can be a lifeline anchor connection or another component.

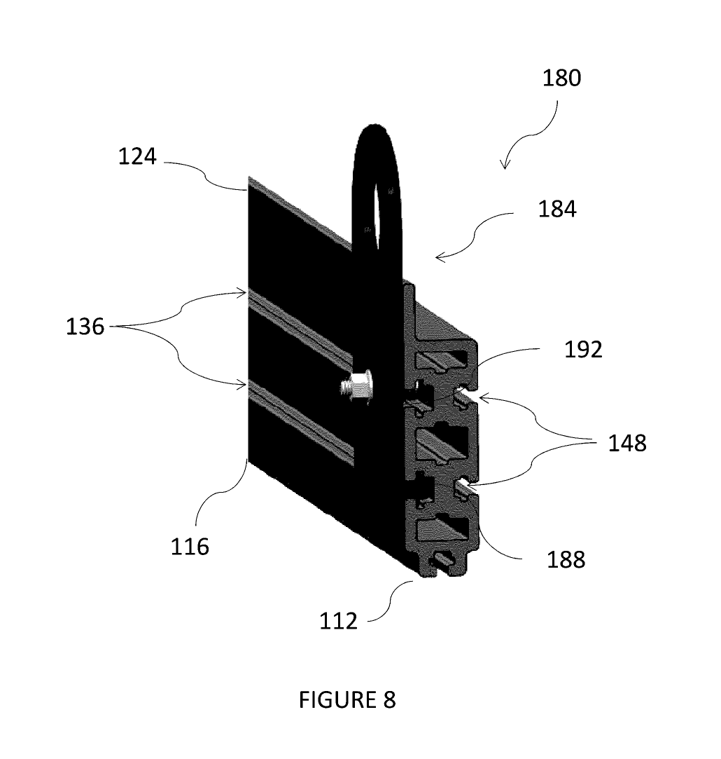

FIG. 8 shows another embodiment with a roof mounted fuel system safety assembly 180 is provided. The safety assembly 180 includes the elongate structural member 100 and a lifeline anchor 184. As noted above, the elongate structural member 100 has a first end 112 and a second end 116. The elongate structural member 100 is configured to be disposed along the roof of a transit vehicle. The elongate structural member 100 has the plurality of channels 136. The channels extend from the first end 112 to the second end 116. The lifeline anchor 184 comprises a first protrusion 188 slideably received in one of the channels 136 and a fastening device 192 slideably received in another one of the channels 136. In other embodiments, the protrusion 188 is not included and the anchor 184 is coupled to the channel 136 by a plurality of, e.g., two, three, four or more fasteners 192.

### B. Multifunctional Support Elements Including Integrated Fluid Passage

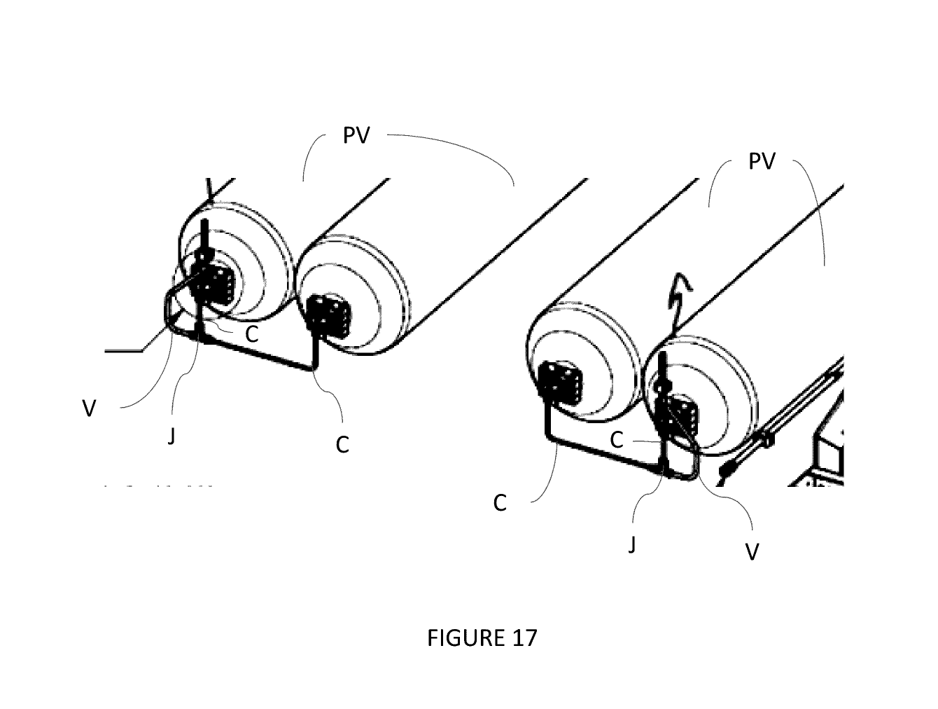

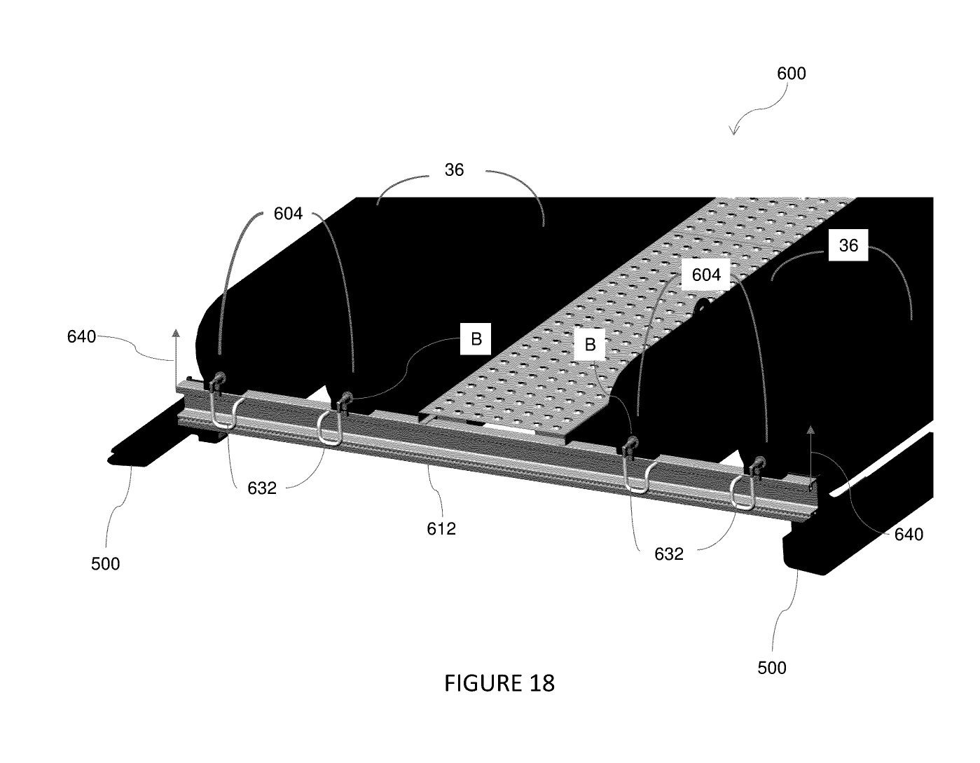

One or more of the structural members 100, 300, 500 can have a gas chamber or a fuel passage disposed therein. FIGS. 17 and 18 illustrate incorporating a vent passage into a structural member to provide a simplified and improved fuel system. FIG. 17 shows a conventional system in which each of a plurality of fuel pressure vessels PV is coupled with a vent line V. In the illustrated system, there are four pressure vessels PV and two vent lines V. In this arrangement, each pressure vessel PV is coupled by an individual hose conduit C to one of the vent lines V. Two conduits C stemming from two pressure vessels PV may be joined at a junction J. The vent lines V can extends from the junction J to a location external to the fuel system of which the assembly of FIG. 17 is a part. For example, the vent line V can extend to an exposed port. Gas in the conduits C can flow out of the vent line V to the atmosphere at the exposed ports and thereby be vented. Such venting can be provided in emergency situations by opening of a pressure relief device, which can incorporate or can be incorporated into the junction J.

This arrangement provides design and manufacturing challenges. For example, the conduits C are of different lengths because the junction J may be disposed at one pressure vessel PV but spaced from an adjacent pressure vessel PV coupled with the junction J. This arrangement requires that some, e.g., half, of the pressure vessels PV be connected by conduit C that has to be routed, supported, and connected to the junction J. The pressure vessel PV spaced apart from the junction J requires a conduit C that is at least twice as long as that connecting the pressure vessel PV closest to the junction J. There can be a large number of conduits C to route and manage in a system. Support fixtures can be provided to manage the conduits, but such fixtures add weight and expense to the system and do no eliminate risk of damage or disconnection arising from the conduit C of greater length.

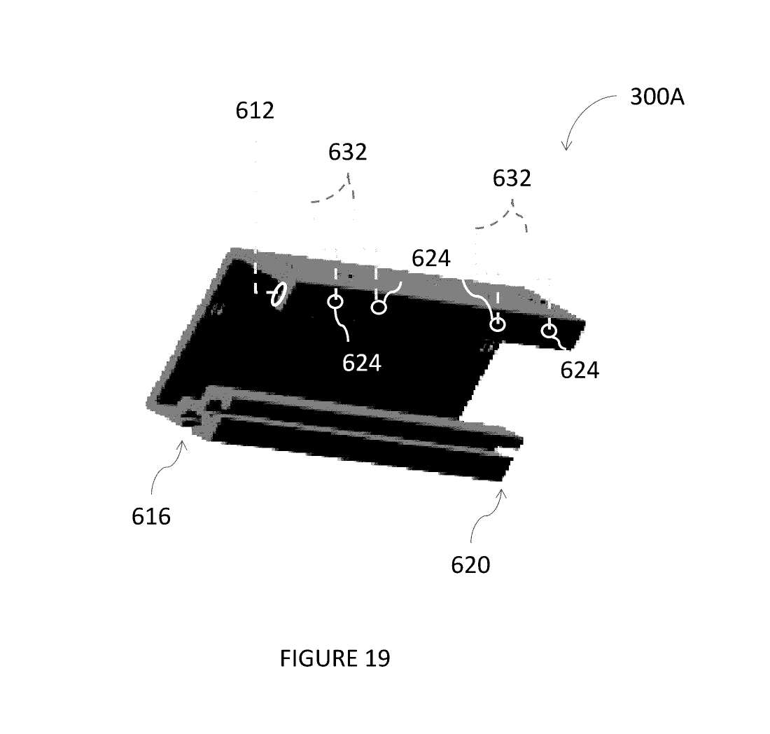

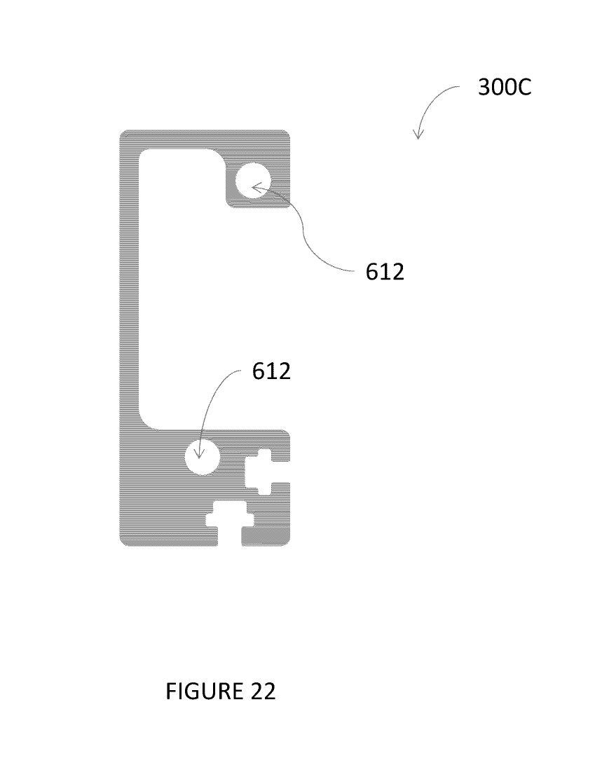

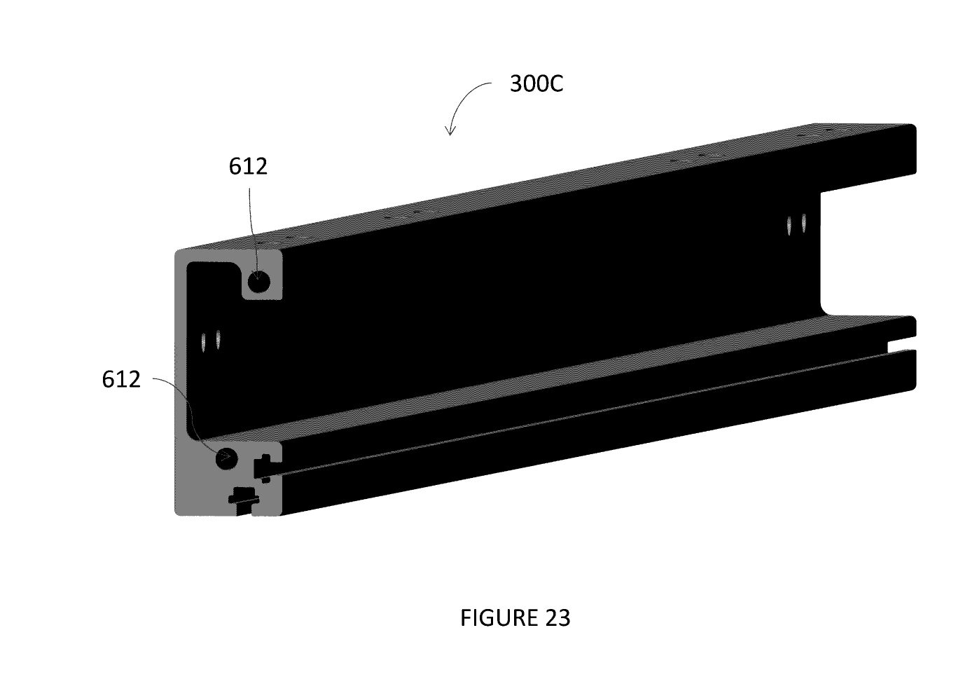

FIG. 18 illustrates a fuel system 600 that improves on the system of FIG. 17. The system 600 includes the fuel pressure vessels 36. The vessels 36 are supported at neck portions 604. The neck portions 604 are supported on, for example, blocks B mounted to a support. For example, the blocks B that support the neck portions 604 can be mounted to an elongate structural member or support 300C. The support 300C is shown in FIGS. 22-23. The support 300C is similar to support 300 described below and can have any of the features thereof. The support 300C has a fluid passage 612 disposed therein. The fluid passage 612 can extend from one end 616 of the support 300C to a second end 620 of the support 300A opposite the first end 616. The fluid passage 612 can be enclosed other than a plurality of access ports 624 disposed along the length of the support 300C. The access ports 624 can include apertures for connecting fluid conduits 632 to the support 300C. The access ports 624 can include a threaded SAE port with an o-ring seal. The access ports 624 can include an NPT taper threaded port. The access ports 624 can include an open hole with the conduit 632 pointed into the hole. The fluid conduit 632 can include a first end fluidly coupled with one of the pressure vessels 36 and a second end fluidly coupled with one of the access port 624. In the illustrated embodiment, the support 300C includes four access ports 624. The support 300C is therefore configured to be coupled with four separate pressure vessels 36. FIG. 19 shows the fluid conduit 632 schematically as dashed lines for clarity.

FIG. 18 shows the fluid passage 612 in a support 300C to illustrate the configuration of the conduits 632. Also, the fluid conduits 632 are shown extending from the support blocks B to the fluid passage 612. Connection of the second ends of the fluid conduit 632 at the access ports 624 can be by any connection means. As shown in FIG. 18, each of the fluid conduits 632 is approximately the same length. Also, because the fluid conduits 632 are relatively short and connect directly into the access port 624, in certain embodiments no additional support is needed for the fluid conduit 632. A vent passage 640 can be provided at one or both ends of the fluid passage 612. FIG. 18 shows a vent line 640 provided on each end of the fluid passage 612. The vent line 640 can be routed in a suitable manner. For example, the vent line 640 can have a first end coupled with an end portion of the support 300C and a second end opposite the first end can be routed to and positioned at an external port to the fuel system 600. The conduit 640 is optional in some embodiments. In such embodiments, the end of the passage 612 can defined by an aperture at the end of the support 300C. Gas from the fuel pressure vessel 36 can thus be vented via the passage 612 directly to the environment through this aperture either inside the cover or outside the cover. Venting can thus be via a separate conduit or directly via the aperture directly from the support 300C.

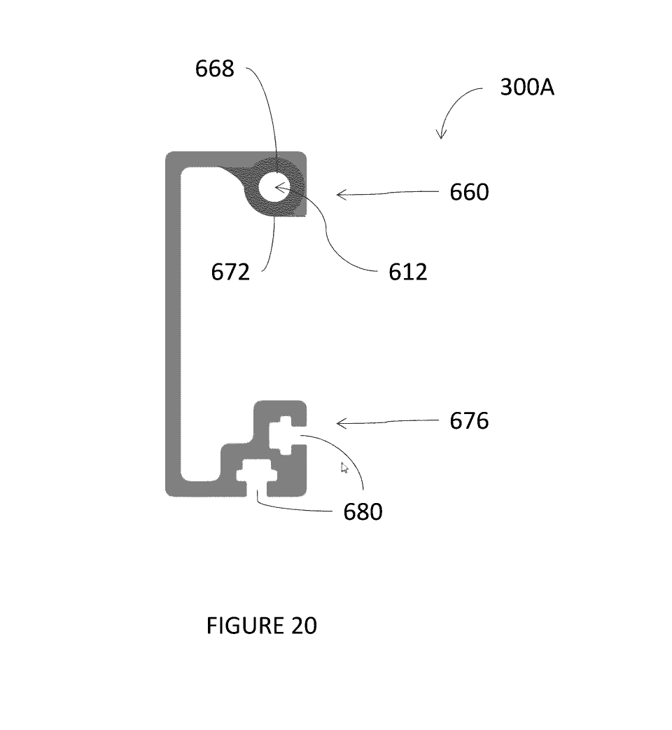

FIG. 20 shows a support 300A which is a modified embodiment of the support 300C in more detail. In particular, an upper portion 660 of the support 300 can comprised an enlarged section 664. The section 664 is sufficiently large to have an aperture 668 that provides access to the fluid passage 612. A wall 672 can be disposed around the fluid passage 612. The wall 672 can be a continuous or monolithic portion of the support 300A. A lower portion 676 of the support 300A can be provided to support components other than the fluid conduit 632. The lower portion 676 can support components such as is described below in connection with FIG. 9. For example, the lower portion 676 can have one or a plurality of channels 680 similar to those discussed before. The channel 680 can be configured to receive a mounting device for coupling a component with the channel 680. The support 300A can be elongated in the direction extending between the upper portion 660 in the lower portion 676 such that there is sufficient room for mounting the fluid conduit 632 as well as other components to the support 300A, as discussed above.

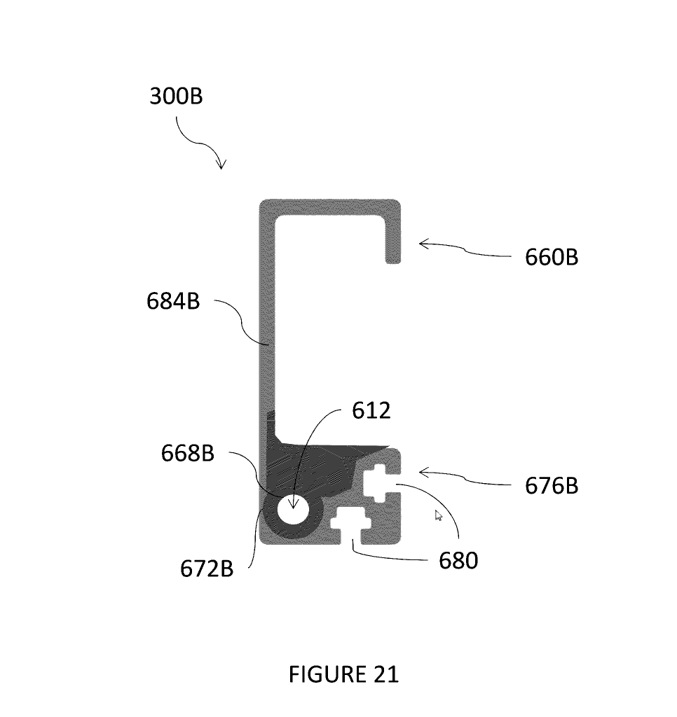

FIG. 21 illustrates a support 300B that is similar to the support 300A except as described differently below. The support 300B includes a lower portion 676B that has a continuous or monolithic wall 672B that surrounds an aperture 668B. The aperture 668B can provide access to the fluid passage 612 which is disposed along the length of the support 300B between the ends thereof. The fluid passage 612 can extend from one end of the support 300B to the opposite end of the support 300B within the lower portion 676B of the support 300B. The support 300B advantageously locates the fluid passage 612 in the same region of the support as the channel 680 for mounting other components. This provides at least partially a greater wall thickness which enables larger pressures to be withstood within the fluid passage 612. The location of the fluid passage 612 permits the routing of the fluid conduit 632 along the enclosed side 684 of the support 300B. This can allow the fluid conduit 632 to extend along the path that is at least partially shielded by the enclosed side 684.

The fuel system 600 has the advantage of simplifying the configuration and/or routing of the fluid conduits 632 as well as the assemblies into which these conduits are incorporated. The simplification can arise from allowing all or more of the conduits 632 to be same length and therefore interchangeable. Also, the average length of the fluid conduit 632 can be shortened to reduce the need for and even potentially eliminate supplemental support fixtures along the length of the fluid conduit 632. Moreover, by shortening the length of the fluid conduit 632 compared to the conduits C the high-pressure contents thereof can be more quickly passed into a rigid structure e.g. into the fluid passage 612 which is surrounded by rigid solid walls 672, 672B.

FIGS. 22 and 23 illustrate the support 300C in more detail. The support is shown in the context of a system in FIG. 18. The support 300C combines many of the features of the supports 300A and 300B. In particular, the support 300C has two passages 612. Either passage can be accessed by one or a plurality of conduits 623.

FIG. 7A shows that other embodiments of supports disclosed herein can be configured to include a passage. For example, the member 100 can be configured to include a passage 158 enclosed within the body of the member 100. The passage 158 can be fluidly coupled with the fuel pressure vessels 36 for any suitable purpose. In some variations, the passage 158 is formed with a round cross-section and is tapped to provide fluid communication with another fuel passage. For example the passage 158 can be coupled in a way that provides for venting of the pressure vessel 36 on appropriate conditions, e.g., for safety. The support member 100 can thus enable a vent passage to extend along the length of a pressure vessel in alternative embodiments. The passage 158 can be integrated into a fuel supply line in one embodiment. For example fuel can flow out of the pressure vessels 36 and be routed to the engine of the bus 10 through the passage 158 and thereafter through one or more downstream fuel passages.

### C. Multifunctional Support Elements Including Pressure Manifold Support

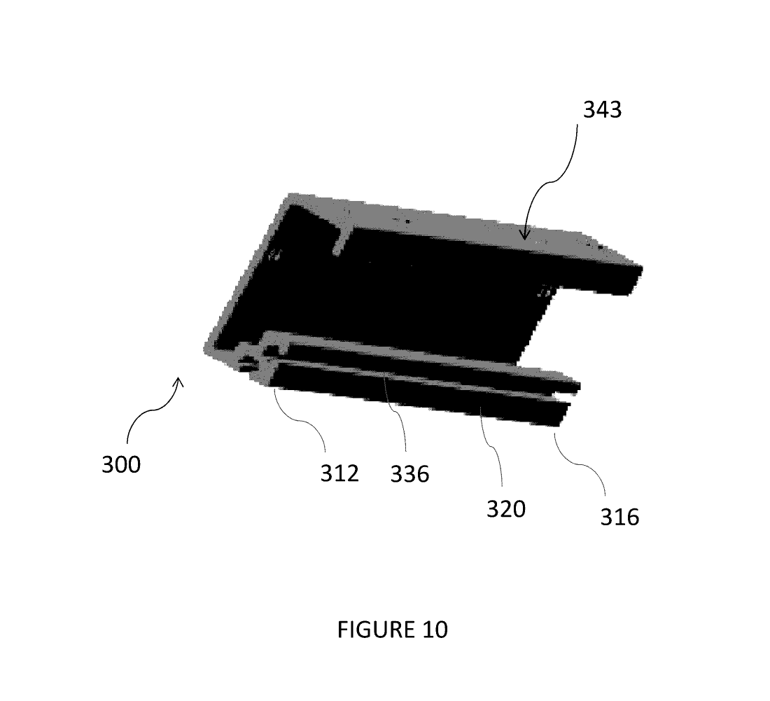

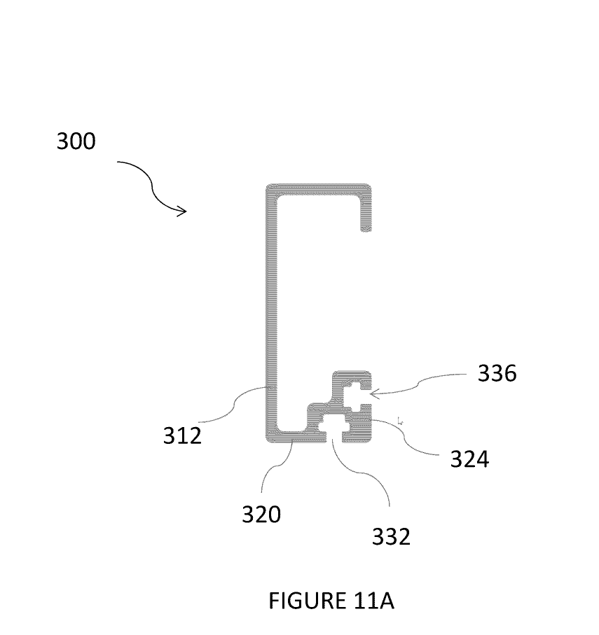

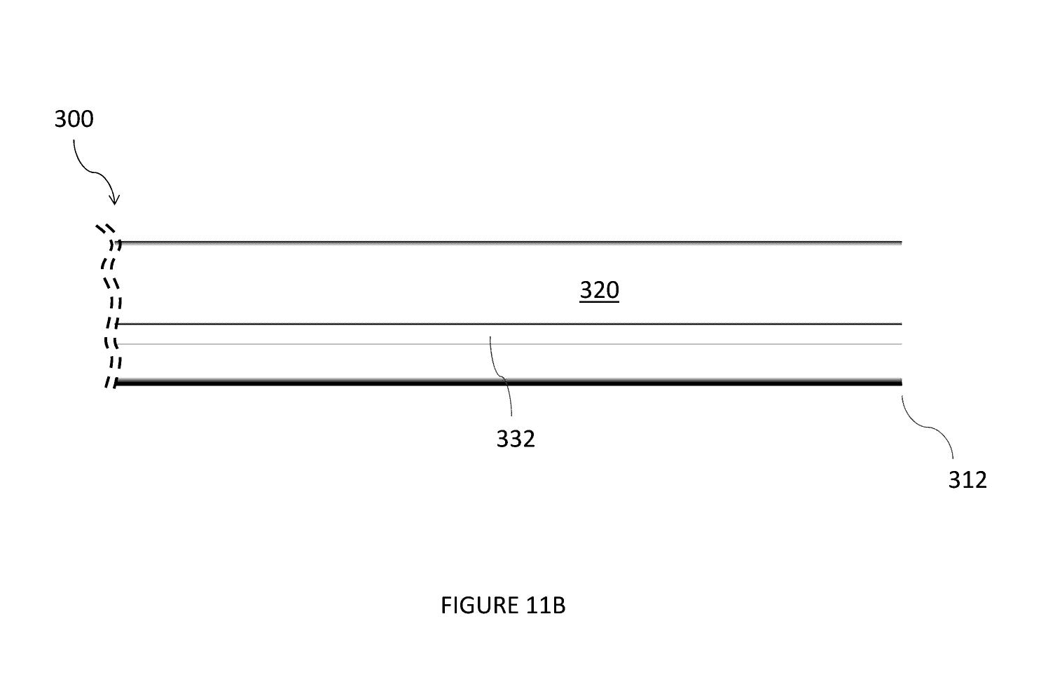

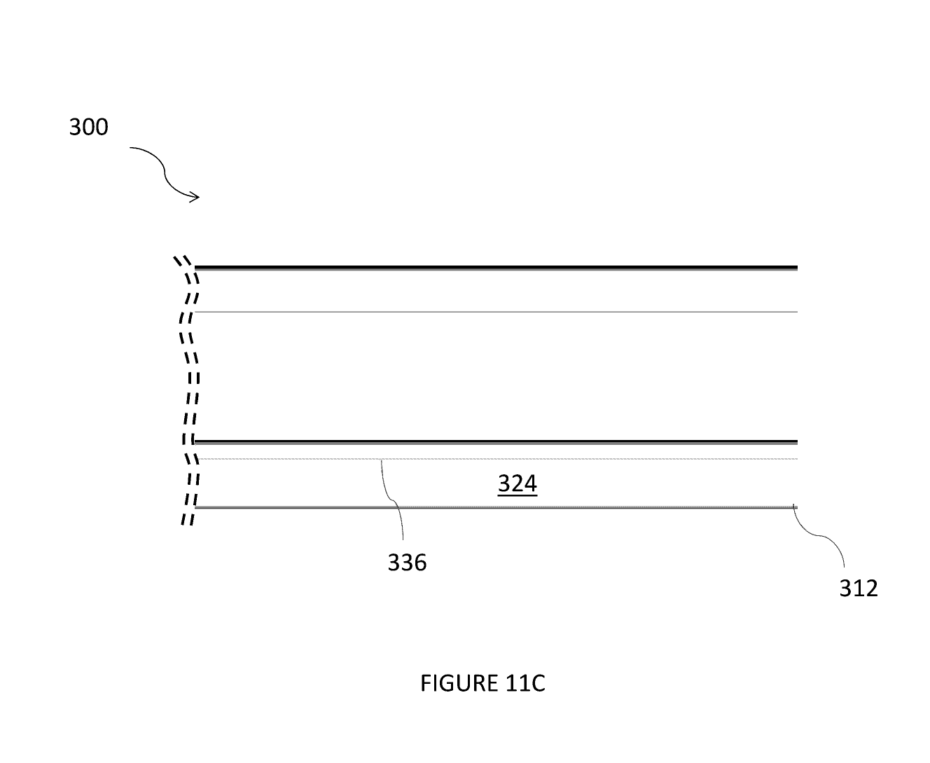

FIG. 9 shows one embodiment of a fuel system support assembly 280 that includes a fuel pressure vessel or pressure vessel 284, a fuel passage 288, and an elongate structural member 300. The elongate structural member 300 is shown in more detail in FIGS. 10-11C.

The fuel passage 288 is coupled with the fuel pressure vessel 284 for conveying fluid into or out of the fuel pressure vessel 284. The elongate structural member 300 has a first end 312 and a second end 316. The member 300 also has a first surface 320 configured to be horizontally oriented and a second surface 324 configured to be vertically oriented when the elongate structural member is mounted to a roof of the bus 10 or another transit vehicle. In other configurations the first and second surfaces 320, 324 can have other orientations in space, including both surfaces being oriented vertically or horizontally.

The first surface 320 has formed therein an anchor feature 332 disposed along the length of the elongate structural member 300. The anchor feature 332 extends from the first end 312 to the second end 316 in one embodiment.

A pressure manifold 340 is supported from the anchor feature 332 at an elevation below the fuel pressure vessel 284. The mounting of the pressure manifold 340 is such that the fuel passage 288 has an uncomplicated path from the pressure vessel 284 to adjacent fitting so that the number of fitting is reduced or is kept to a minimum. For example, the path can involve a number of gentle bends, but need not include multiple or in some cases any T-fittings to provide a pathway for the fuel passage 288. A fuel line 341 can be coupled with the pressure manifold 340 for flowing fuel into the pressure vessels 284. The pressure manifold 340 is configured to distribute the fuel incoming in the fuel line 341 to the pressure vessels. In one embodiment, the pressure manifold 340 comprises a cylindrical body that has passages formed therein that splits fuel flowing from the fuel line 341 to the pressure vessels 284 into passages that distribute fuel to each of a plurality of pressure vessels 284. Fuel flows out of the pressure manifold 340 to the pressure vessels through the fuel passages 288. This arrangement allows for the elimination of many T-junctions to split the flow that would otherwise add to the cost and weight of the system.

The second surface 324 can also include an anchor feature disposed therein. For example, a channel 336 can extend from the first end 312 to the second end 316. The channel 336 can be accessed from the first end 312 and the second end 316 in one embodiment. In other embodiments, the channel 336 is accessible from the first end 312 or the second end 316. In some embodiments, the channel 336 is open to one of the first end 312 and the second end 316, but is closed at a location between the first and second ends.

The elongate structural member 300 also has a surface 343 that is adapted for mounting additional manifolds or for securing portions of the fuel passage 288. FIG. 9 shows the mounting of these components. By mounting features to the surface 343 and to the anchor feature 332, the elongate structural member 300 operates as a multifunctional member. The anchor features 332 can be used to mount a mounting plate 342. The plate 342 can be mounted between the anchor features 332 of adjacent members 300 as shown in FIG. 9. The plate 342 can be used to mount to the roof 24 of the bus 10, to structurally support the fuel system. In other embodiments, the plates 342 can support other components as needed. In addition to simplifying the routing of the fuel passage, this multi-functionality helps keep the structural members to a minimum to keep the weight and complexity of the support system down.

The elongate structural member 300 also operates as a multifunctional member by supporting mounting blocks B configured to retain and support a neck portion of pressure vessels 284. In the illustrated embodiment, mounting blocks B support next portions disposed at each end of each of the pressure vessels 284.

FIG. 9 shows that in higher assemblies a fuel support system can include a plurality of the elongate structural members 300, where one of the elongate structural member 300 interacts with a first group of fuel pressure vessels and another one of the elongate structural member 300 interacts with a second group of fuel pressure vessels. Also, the elongate structural members 300 are shown supported by one or more frame members 350 that are disposed below the pressure vessels and that carry the load to the frame of the vehicle.

### D. Multifunctional Support Elements Including Cover Hinge Support

FIGS. 12-16 show an embodiment of a fuel system cover assembly 480 that includes the fuel pressure vessel cover 32, a hinge 494 and a structural member 500. The structural member 500 has an outboard side 504 and an inboard side 508. The structural member 500 also includes a first end 512 configured to couple with a vehicle at a first location, a second end 516 configured to couple with the vehicle at a second location. The structural member 500 includes an elongate body 520 disposed between the first end 512 and the second end 516. The elongate body 520 has an arcuate channel 524 disposed therein along the outboard side 504. The arcuate channel 524 is open along the outboard side thereof. The elongate body also has an auxiliary anchor feature 528 disposed on an inboard side thereof. The anchor features 136, 148, 528 and/or the channel 336 can be configured to couple with an auxiliary component that is not shown, but could include fuel tubes, vent tubes, safety relief devices, temperature or manually activated pressure relief devices, electrical cables and harnesses, sensors, sensor cables, and other anchor points or attachment points. The anchor features 136, 148, 528 and the channel 336 can also be connected with plumbing anchorage devices and electrical cabling anchorage devices.

The hinge 494 has a cylindrical portion 540 disposed in the arcuate channel 524 and a coupler 548 disposed away from the cylindrical portion 540. The movement enabled by the hinge can be provided by any suitable structure, such as a living hinge, e.g., a body having a flexible section to provide for bending. In other embodiments, pivot pins or other hinge components can be included. The fuel pressure vessel cover 32 is secured to the coupler 548 of the hinge 494. FIG. 12A shows the fuel pressure vessel cover 32 in a closed position, e.g., with a top portion projection over where a fuel pressure vessel would be. To open the cover 32, the top portion is swung toward the right in the page. As it moves, the cylindrical portion 540 of the hinge 494 rotates clockwise in FIG. 12A to a portion where the top portion of the cover 32 is away from the fuel pressure vessels.

The auxiliary anchor feature 528 can have a complex shape allowing the heads of bolts or member with enlarged ends to be slideable in the channel thereof but not removable in a direction perpendicular to the channel. The anchor feature 528 can be located at any suitable location, e.g., at a higher elevation than the arcuate channel 524. In one embodiment, the anchor feature 528 is disposed at an angle to the vertical and to the horizontal to provide improved visibility or access around a pressure vessel, which can be adjacent to the feature 528 in a fuel pressure vessel assembly. The anchor feature 528 of support member 500 can be optional as illustrated in FIG. 18.

In various embodiments, the structural members comprise extrusions that have a plurality of independent channels extending the length thereof to anchor separate fuel system components. The extrusion can be formed of any suitable material, such as 6061 structural aluminum. The extrusion and the anchor features can be configured to support many thousands of pounds of weight.

### III. Fuel System Cover Adjustment System

FIGS. 12-16 show that certain embodiments of the fuel system cover assembly 480 can be configured for small adjustments in fit of the cover 32 relative to a vehicle body panel such as the roof 24 of the bus 10 or other on-road or off-road vehicle. These small adjustments enable the gap between the cover 32 and the roof 24 to be adjusted to minimize ingress of the harsh elements in which the bus 10 operates.

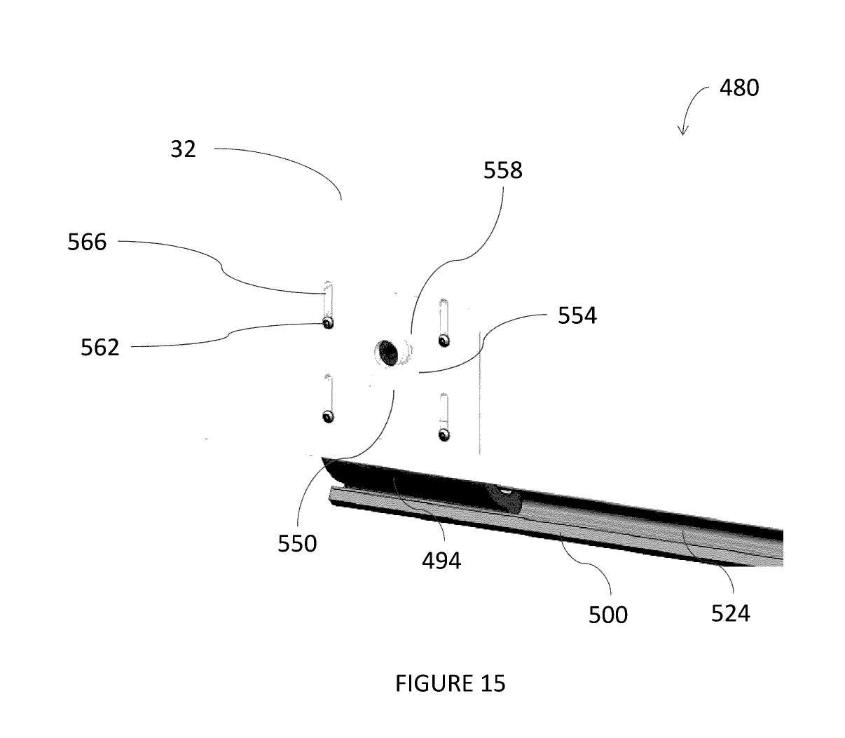

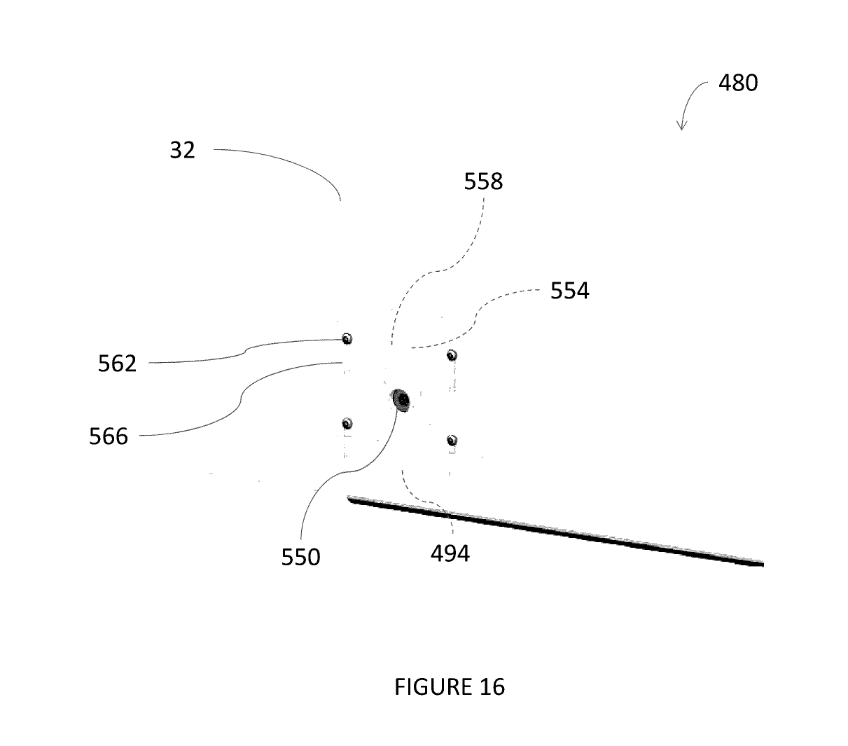

FIGS. 15 and 16 show that in one variation, the cover assembly 480 has a cam 550 rotatably mounted on the cover 32. The cam can be mounted to the cover 32 in any suitable way. For example, an aperture can be formed from the outer surface to the inner surface of the cover 32. The cam can include a cylindrical plug mounted in the aperture. The cylindrical plug can have a tool interface disposed on an outboard side thereof. The inboard side of the cylindrical plug can be coupled with a lobe of the cam 550. The lobe of the cam can include a cam surface 554 configured to engaged a follower surface 558.

In one embodiment, the hinge 494 has an opening formed therein in which the lobe of the cam 550 is disposed. The cam surface 554 is positioned in the opening such that the range of motion of the cam 550 results in the cam surface 554 acting on the follower surface as described below. The follower surface 558 can be located at or in the opening of the hinge 494. FIGS. 15 and 16 show that the follower surface 558 can include an upper peripheral surface of the opening in the hinge 494. The follower surface 558 is a contact surface disposed on the hinge 494.

In addition to the cam 550 and the follower 558, the cover assembly 480 can include a guide portion to control the movement of the cover 32 relative to the hinge 494. The guide portion can include one or more protrusions 562 secured to the hinge 494 and one or more slots 566 formed in the cover 32. FIGS. 15 and 16 show that the guide portion can include four protrusions 562 extending outboard from the hinge 494. The protrusions 562 can include set screws, rivets, or other simple rigid members. The guide slot(s) 566 are slideably coupled with the guide member(s) 562.

The adjustment of the cover can be carried out as follows. If the protrusion(s) 566 include a securement function, such as with a set screw the protrusions are loosened. Thereafter, the cam 550 can be rotated to cause the cam surface 554 to act on the follower surface 558. As the cam surface 554 acts on the follower surface 558 the cover 32 is raised or lowered. The movement of the cover 32 relative to the hinge 494 is guided by the guide portion, including the protrusion(s) 562 and slot(s) 566 if included.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

As used herein, the relative terms “inboard” and “outboard” when describing the location of certain features shall be defined from the perspective of the side and the midline of the vehicle. Thus, outboard refers to the direction 612 of the lateral sides of the vehicle and inboard refers to the direction toward the central vertical plane of the vehicle.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

Any methods disclosed herein need not be performed in the order recited. The methods disclosed herein include certain actions taken by a practitioner; however, they can also include any third-party instruction of those actions, either expressly or by implication.

1. A fuel system, comprising:
a fuel pressure vessel comprising an enclosed volume configured to store a pressurized gas fuel and a neck portion disposed adjacent to an end of the enclosed volume;
a support member configure to be coupled with a vehicle, the support member comprising:
a first end;
a second end; and
an elongate body extending between the first end and the second end;
a fluid passage disposed in the support member; and.
a fluid conduit coupling the fuel pressure vessel to the fluid passage disposed in the support member,
wherein the fluid passage in the support member and the fluid conduit are configured to vent fuel from the pressure vessel to the atmosphere.

2. The fuel system of claim 1, further comprising:
a second fuel pressure vessel; and
a second fluid conduit coupling the second pressure vessel to the fluid passage disposed in the support member, wherein gas in the second fuel pressure vessel can be vented to the atmosphere through the fluid passage in the support member.

3. The fuel system of claim 2, wherein the fluid conduit and the second fluid conduit have substantially the same length.

4. The fuel system of claim 1, wherein the elongate body further comprises an channel extending from at least one of the first and second end toward the other of the first and second ends and having sufficient length to permit a component to be mounted thereto at a range of positions.

5. The fuel system of claim 1, wherein the elongate body of the support member is disposed along a longitudinal axis, and wherein the fuel system is configured to be mounted to a roof of a vehicle such that the longitudinal axis is transverse to a longitudinal axis of the vehicle.

6. The fuel system of claim 1, wherein the support member is disposed along or transverse to a longitudinal axis, and wherein the fuel system is configured to be mounted to a vehicle such that the longitudinal axis is along or transverse to the longitudinal axis of the vehicle.

7. A fuel system, comprising:
a fuel pressure vessel comprising an enclosed volume configured to store a pressurized gas fuel and a neck portion disposed adjacent to an end of the enclosed volume;
a support member configure to support the fuel pressure vessel and to be coupled with a vehicle, the support member comprising a fluid passage disposed therein between the ends thereof; and
an aperture in fluid communication with the fluid passage to vent fuel from the pressure vessel to the atmosphere.

8. The fuel system of claim 7, further comprising a plurality of ports formed in the support member, each of the ports being in fluid communication with a fuel pressure vessel.

9. The fuel system of claim 8, further comprising a plurality of fuel conduits, each fuel conduit being disposed between a fuel pressure vessel and one of the ports formed in the support member.

10. The fuel system of claim 7, wherein the support member comprises a portion of a support assembly configured to support a neck of the fuel pressure vessel.

11. A structural member for securing components of a fuel system to a vehicle frame, the structural member comprising:
a first end, a second end, and an elongate body extending therebetween;
the elongate body having a first surface having formed therein a first anchor feature, the first anchor feature extending from at least one of the first and second ends toward the other of the first and second ends and having sufficient length to permit a component to be mounted thereto at a range of positions; and
the elongate body having a second surface having formed therein a second anchor feature, the second anchor feature extending from at least one of the first and second ends toward the other of the first and second ends and having sufficient length to permit a component to be mounted thereto at a range of positions.

12. A system comprising:
the structural member of claim 11, wherein the first anchor feature comprises a channel formed in the first side of the elongate body; and
a tube clamp assembly comprising a clamping portion and an anchor portion, the anchor portion slideable in the channel and adapted to be secured at a selected location along the elongate body of the structural member.

13. A system comprising:
the structural member of claim 11, wherein the first anchor feature comprises a channel formed in the first side of the elongate body; and
a wire harness comprising a wire retaining portion and an anchor portion, the anchor portion slideable in the channel and adapted to be secured at a selected location along the elongate body of the structural member.

14. A system comprising:
the structural member of claim 11, wherein the first anchor feature comprises a channel formed in the first side of the elongate body; and
a lifeline anchor comprising a rigid loop for connecting to a safety lifeline and an anchor portion, the anchor portion slideable in the channel and adapted to be secured at a selected location along the elongate body of the structural member.

15. A system comprising:
the structural member of claim 11, wherein the first anchor feature comprises a channel formed in the first side of the elongate body; and
a gas chamber or passage disposed in or coupled with the structural member, the gas chamber or passage configured to be pressurized with a gaseous fuel or to vent fuel to the atmosphere.

16. A system comprising:
the structural member of claim 11, wherein the first anchor feature comprises a channel formed in the first side of the elongate body; and
a pressure relief device in fluid communication with a gas chamber.

17-53. (canceled)
